(19) United States
(12) Patent Application Publication
(10) Pub. No.: US 2025/0124297 A1
(43) Pub. Date: Apr. 17, 2025

(54) CONTROLLING REINFORCEMENT LEARNING AGENTS USING GEOMETRIC POLICY COMPOSITION

(71) Applicant: DeepMind Technologies Limited, London (GB)

(72) Inventors: Mark Daniel Rowland, London (GB); Shantanu Yogeshraj Thakoor, London (GB); Andre da Motta Salles Barreto, London (GB); Diana Luiza Borsa, London (GB); William Clinton Dabney, London (GB); Remi Munos, London (GB)

(21) Appl. No.: 18/834,208

(22) PCT Filed: Jan. 30, 2023
(86) PCT No.: PCT/EP2023/052205

§ 371 Date: Jul. 29, 2024

Related U.S. Application Data
(60) Provisional application No. 63/304,482, filed on Jan. 28, 2022.

(51) Int. Cl. G06N 3/092; G06N 3/0455

(52) U.S. Cl. CPC G06N 3/092; G06N 3/0455

(57) ABSTRACT

Methods, systems, and apparatus, including computer programs encoded on a computer storage medium, for controlling a reinforcement learning agent in an environment. One of the methods may include maintaining data specifying a base policy set comprising a plurality of base policies for controlling the agent; receiving a current observation characterizing a current state of the environment; generating, for each of the plurality of base policies, one or more predicted future observations characterizing respective future states of the environment that are subsequent to the current state of the environment; using the predicted future observations generated for the plurality of base policies to determine a respective estimated value for each composite policy in a composite policy set with respect to the current state of the environment; and selecting an action using the respective estimated values for the composite policies.

### CROSS-REFERENCE TO RELATED APPLICATION

This application claims priority to U.S. Provisional Application No. 63/304,482, filed on Jan. 28, 2022. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a reinforcement learning system that controls an agent interacting with an environment by, at each of multiple time steps, processing data characterizing the current state of the environment at the time step (i.e., an “observation”) to select an action to be performed by the agent.

In particular, the reinforcement learning system selects actions to be performed by the agent by applying a generalized policy improvement technique to a diverse pool of different action selection policies that might be used to control the agent. The pool of different action selection policies can include a set of base, e.g. Markov, policies and a set of composite, e.g. non-Markov, policies. A base policy can be any of a variety of fixed action selection policies (e.g., a policy that, when used, consistently controls the agent to perform a same single action) or learned action selection policies (e.g., a policy implemented as an already trained action selection policy neural network), while a composite policy is an action selection policy that switches between executing two or more of these base policies with a switching probability, e.g. a given or fixed probability.

To evaluate each action selection policy during the generalized policy improvement process, the system makes use of a sampling-based reward estimation technique based on network outputs generated by using generative neural networks that are each configured to model future state-visitation distributions when the agent is controlled using a corresponding base policy.

In addition to directly controlling an agent, some implementations of the system can be used in a transfer learning scenario, where a set of policies have been separately learned and the system uses the separately learned policies as the set of base policies in order to act to maximize a new reward function. Some implementations of the system can also be used to improve a reinforcement learning policy to obtain a new policy from a set of base policies, where the base policies include those that were generated at multiple different iterations of the policy improvement technique.

In one aspect there is described a computer-implemented method for controlling a reinforcement learning agent in an environment. The method comprises maintaining data specifying a base policy set comprising a plurality of base policies for controlling the agent, receiving a current observation characterizing a current state of the environment, and generating, for each of one or more of the plurality of base policies, one or more predicted future observations characterizing respective future states of the environment that are subsequent to the current state of the environment by using an environment dynamics neural network that corresponds to the base policy. Each environment dynamics neural network is configured (trained) to receive an environment dynamics network input comprising an input observation characterizing an input state of the environment and a respective action selected by using the corresponding base policy to be performed by the agent in response to the input observation, and to process the environment dynamics network input to generate a predicted future observation characterizing a respective future state of the environment.

The method uses the predicted future observations generated for the plurality of base policies to determine a respective estimated value for each composite policy in a composite policy set with respect to the current state of the environment, e.g. based on estimated future rewards from the environment.

Each composite policy is generated based on the base policy set and, in each composite policy, each of one or more of the plurality of base policies is subsequently used (serially, i.e. in turn) to select (supposed) actions to be performed by the agent in response to a corresponding number of consecutive future observations, as predicted by the corresponding environment dynamics network (the number of future observations corresponding to a number of the supposed actions). In general at least some of the composite policies use multiple base policies.

The method selects, as a current action to be performed by the agent in response to the current observation characterizing the current state of the environment, an action using the respective estimated values for the composite policies. Thus, in implementations, the method can be considered as selecting one of the composite policies based on the estimated values for the composite policies, e.g. selecting the current action according to a composite policy that has a highest estimated value.

In implementations, in each composite policy, the corresponding number of consecutive future observations in response to which each base policy is used to select actions is determined in accordance with a given switching probability (α). The switching probability may be a probability of switching away from a base policy currently used to select supposed actions, to another base policy. The number of consecutive future observations processed by a base policy to select actions can be determined by evaluating (sampling from) a geometric distribution function over the switching probability (Geometric(α)), that defines a probability that a switch occurs after T time steps.

It is not necessary to have an explicit reward estimator. However a known, e.g. deterministic, or learnt reward estimator can be used to estimate rewards from the environment, e.g. for predicted future observations.

In some implementations some or all of the base policies can be pre-trained, e.g. using an imitation or reinforcement learning technique, and/or a selected composite policy can be added to the set of base policies to (iteratively) improve the policies.

The environment dynamics neural network corresponding to a base policy can be (pre)trained, e.g. obtaining training samples, i.e. observations, by interacting with the environment using the base policy and training the environment dynamics neural network using a cross-entropy loss. In some implementations an environment dynamics neural network is trained by optimizing a cross-entropy temporal-difference (CETD) loss, i.e. a cross-entropy loss in which training samples are obtained by sampling a state of the environment (i.e. obtaining an observation), and deciding whether or not to stop according to a probability (e.g. B, later) and use this state or to continue by sampling an action using the base policy, acting with the action, and then returning a sample (observation).

In some implementations an environment dynamics neural network may comprise a conditional β-VAE model, in particular conditional on an input observation such as a predicted future observation and on a (supposed) action. A β-VAE model may be characterized as a variational autoencoder with a regularization term that has a weight β>1. In some other implementations other models may be used, e.g. a model based on normalizing flows.

Particular embodiments of the subject matter described in this specification can be implemented so as to realize one or more of the following advantages.

Actions to be performed by an agent interacting with an environment to perform a complex task such as a continuous, robotic control task, can be effectively selected. In other words, the actions can be effectively selected to maximize the likelihood that a desired result, such as performance of the given task, will be achieved. In particular, the actions are selected according to an improved policy that is automatically determined from, and generally improves over, a collection of base policies for controlling the agent.

By using generative neural networks configured to model the discounted state-visitation distribution of each different base policy, the described techniques can generate and evaluate an arbitrary number of new composite policies from the base policies. The described techniques allow for exploration through a more diverse space of action selection policies, as the new policies need not have the same property as the base policies, e.g., need not be Markovian, while imposing no additional computation overhead devoted to the training of the system because no extra neural networks (or extra training of the existing neural networks) will be needed to evaluate the new composite policies. The can allow the system to control the agent to achieve superior performance despite only having been trained with comparable compute and memory usage to what might be needed by previous agent control systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an example reinforcement learning system;

FIG. 2A is an illustration of a rollout for selecting an action using a composite policy.

FIG. 2B is an illustration of generating predicted future observations.

FIG. 3 is a flow diagram of an example process for controlling a reinforcement learning agent in an environment.

FIG. 4 is a flow diagram of an example process for determining an estimated value for a composite policy with respect to a current state of an environment.

Like reference numbers and designations in the various drawings indicate like elements.

### DETAILED DESCRIPTION

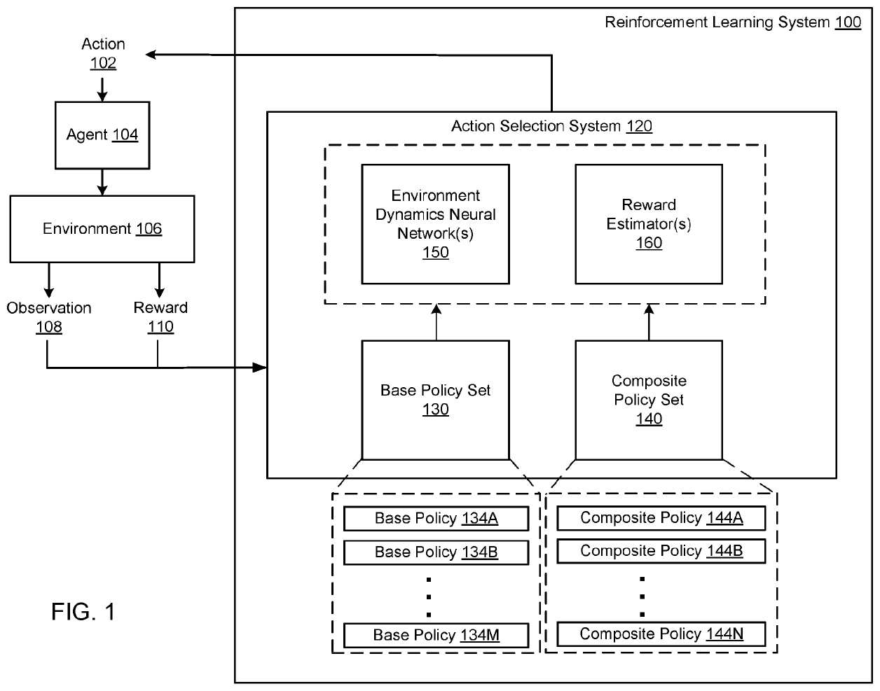

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 selects actions 102 to be performed by an agent 104 interacting with an environment 106 at each of multiple successive time steps. At each time step, the system 100 receives data characterizing the current state of the environment 106, e.g., an image of the environment 106, and selects an action 102 to be performed by the agent 104 in response to the received data. Data characterizing a state of the environment 106 will be referred to in this specification as an observation 108.

Once the reinforcement learning system 100 selects an action to be performed by the agent 104, the reinforcement learning system 100 can cause the agent 104 to perform the selected action. For example, the system can instruct the agent 104 and the agent can 104 perform the selected action. As another example, the system can directly generate control signals for one or more controllable elements of the agent 104. As yet another example, the system 100 can transmit data specifying the selected action to a control system of the agent 104, which controls the agent 104 to perform the action. Generally, the agent 104 performing the selected action results in the environment 106 transitioning into a different state.

The system 100 described herein is widely applicable and is not limited to one specific implementation. However, for illustrative purposes, a small number of example implementations are described below.

In some implementations, the environment 106 is a real-world environment, the agent 104 is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent 104 may be a robot interacting with the environment 106 to accomplish a specific task, e.g., to locate or manipulate an object of interest in the environment or to move an object of interest to a specified location in the environment or to navigate to a specified destination in the environment.

In these implementations, the observations 108 may include, e.g., one or more of: images, object position data, and sensor data to capture observations as the agent interacts with the environment, for example sensor data from an image, distance, or position sensor or from an actuator. For example in the case of a robot, the observations 108 may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations 108 may similarly include one or more of the position, linear or angular velocity, force, torque or acceleration, and global or relative pose of one or more parts of the agent. The observations may be defined in 1, 2 or 3 dimensions, and may be absolute and/or relative observations. The observations 108 may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions 102 may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment 106 is a simulation of the above-described real-world environment, and the agent 104 is implemented as one or more computers interacting with the simulated environment. For example the simulated environment may be a simulation of a robot or vehicle and the reinforcement learning system 100 may be trained on the simulation and then, once trained, used in the real-world.

In some implementations the environment 106 is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent 104 may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent 104 may comprise a task to manufacture the product or an intermediate version or component thereof. As another example, a task performed by the agent 104 may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In response to some or all of the actions performed by the agent 104, the reinforcement learning system 100 receives a reward 110. Each reward is a numeric value received from the environment 106 as a consequence of the agent performing an action, i.e., the reward will be different depending on the state that the environment 106 transitions into as a result of the agent 104 performing the action. The rewards 110 may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control usage of a resource, the metric may comprise any metric of the usage of the resource. In the case of a task which is to control an electromechanical agent such as a robot to perform a manipulation of an object, the reward may indicate whether the object has been correctly manipulated according to a predefined criterion.

In general, observations 108 of a state of the environment 106 may comprise any electronic signals representing the functioning of electronic and/or mechanical items of equipment. For example a representation of the state of the environment 106 may be derived from observations 108 made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case that the agent 104 is a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor (e.g. mounted on the machine). Sensors such as these may be part of or located separately from the agent in the environment.

In some implementations the environment 106 is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment, such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions 102 may be any actions that have an effect on the observed state of the environment 106, e.g. actions configured to adjust any of the sensed parameters described below. These may include actions 102 to control, or to impose operating conditions on, the items of equipment or the ancillary control equipment, e.g. actions that result in changes to settings to adjust, control, or switch on or off the operation of an item of equipment or an item of ancillary control equipment.

In general, the observations 108 of a state of the environment 106 may comprise any electronic signals representing the functioning of the facility or of equipment in the facility. For example a representation of the state of the environment 106 may be derived from observations 108 made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards may relate to a metric of performance of a task relating to the efficient operation of the facility. For example in the case of a task to control, e.g. minimize, use of a resource, such as a task to control use of electrical power or water, the metric may comprise any metric of use of the resource.

In some implementations the environment 106 is the real-world environment of a power generation facility, e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards may relate to a metric of performance of a task relating to power distribution. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations 108 of a state of the environment 106 may comprise any electronic signals representing the electrical or mechanical functioning of power generation equipment in the power generation facility. For example a representation of the state of the environment 106 may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment 106 may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment 106 may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some further applications, the environment 106 is a real-world environment and the agent manages distribution of tasks across computing resources e.g. on a mobile device and/or in a data center. In these implementations, the actions may include assigning tasks to particular computing resources. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed. As another example the agent may comprise a computer-implemented (computational) task manager, e.g. as described above, the environment may comprise a physical state of a computational device, and the observation may comprise data from one or more sensors configured to sense the state of the computational device. Then the agent may include actions to control the computational tasks to manage the physical state, e.g. environmental operating conditions, of the computational device.

As further example, the actions may include presenting advertisements, the observations may include advertisement impressions or a click-through count or rate, and the reward may characterize previous selections of items or content taken by one or more users.

In some cases, the observations 108 may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment 106 may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards may comprise one or more metrics of performance of the design of the entity. For example rewards may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment 106 may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent 104 may not include a human being (e.g. it is a robot). Conversely, in some implementations the agent 104 comprises a human user of a digital assistant such as a smart speaker, smart display, or other device. Then the information defining the task can be obtained from the digital assistant, and the digital assistant can be used to instruct the user based on the task.

For example, the reinforcement learning system 100 may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system 100. The reinforcement learning system 100 chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. The reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv: 2209.14375) or Chinchilla (Hoffmann et al. arXiv: 2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In some implementations, the environment 106 may not include a human being or animal. In other implementations, however, it may comprise a human being or animal. For example, the agent may be an autonomous vehicle in an environment 106 which is a location (e.g. a geographical location) where there are human beings (e.g. pedestrians or drivers/passengers of other vehicles) and/or animals, and the autonomous vehicle itself may optionally contain human beings. The environment 106 may also be at least one room (e.g. in a habitation) containing one or more people. The human being or animal may be an element of the environment 106 which is involved in the task, e.g. modified by the task (indeed, the environment may substantially consist of the human being or animal). For example the environment 106 may be a medical or veterinary environment containing at least one human or animal subject, and the task may relate to performing a medical (e.g. surgical) procedure on the subject. In a further implementation, the environment 106 may comprise a human user who interacts with an agent 104 which is in the form of an item of user equipment, e.g. a digital assistant. The item of user equipment provides a user interface between the user and a computer system (the same computer system(s) which implement the reinforcement learning system 100, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation 108 at any given time step may include data from a previous time step that may be beneficial in characterizing the environment, e.g., the action performed at the previous time step, the reward received at the previous time step, or both.

At each time step, the reinforcement learning system 100 selects the action 102 to be performed by the agent 104 at the time step using an action selection system 120. The action selection system 120 is a system that obtains a set of base policies 130 and a set of composite policies 140 for controlling an agent 104 to perform a particular task and uses multiple environment dynamics neural networks 150 and one or more reward estimators 160 to evaluate each of one or more policies included in the base policy set 130 or the composite policy set 140 and to use the evaluation results to determine the actions 102 to be performed by the agent 102 when performing the particular task.

The action selection system 120 can receive the base policy set 130 in any of a variety of ways. For example, the system 120 can receive data defining the base policies as an upload from a remote user of the system over a data communication network, e.g., using an application programming interface (API) made available by the system 100. As another example, the system 120 can receive an input from a user specifying which data that is already maintained by the system 120, or another system accessible by the system 120, should be used as the data defining the base policies.

The set of base policies 130 include multiple base policies 134A-M, where each base policy defines which action should be performed by the agent at each of multiple time steps (according to the base policy). The multiple base policies 134A-M reflect different approaches to performing the same particular task. Put another way, the multiple base policies 134A-M represent different solutions to the same technical problem of agent control.

One example of a base policy is a fixed action selection policy. For example, the base policy can be a policy that, when used, consistently controls the agent to perform a same single action. As another example, the base policy can be a policy that selects actions with uniform randomness. As yet another example, the base policy can be a policy that selects actions according to some hardcoded logic.

Another example of a base policy is a learned action selection policy. In this example the policy can be implemented as a trained base policy neural network which has been configured, i.e., through training, to, at each of multiple time steps, process a base policy network input that includes a current observation characterizing the current state of the environment, in accordance with learned values of the network parameters, to generate a base policy network output that specifies an action to be performed by the agent in response to the current observation. Each base policy neural network can have any appropriate architecture, e.g., feedforward or recurrent, such as comprising a multi-layer perceptron (MLP) with tanh activation layer(s), or a convolutional neural network, that allows the policy neural network to map an observation to a base policy network output for selecting actions. In this example, the training of each base policy neural network can either take place locally at the reinforcement learning system 100, or can alternatively take place at a remote, cloud-based training system.

For example, the base policy network output may be a probability distribution over the set of possible actions. As another example, the base policy network output may comprise a Q value that is an estimate of the long-term time-discounted reward that would be received if the agent performs a particular action in response to the observation. As another example, the base policy network output may identify a particular action, e.g., by defining the mean and variance of the torque to be applied to each of multiple movable components, e.g., joints, of a robot.

The set of composite policies 140 include multiple composite policies 144A-N, where each composite policy similarly defines which action should be performed by the agent at each of multiple time steps (according to the composite policy). In some cases, the set of composite policies 140 can be obtained by the action selection system 120 from a user or another system, e.g., from the same user or system that also provided the set of base policies 130. In other cases, the set of composite policies 140 can be generated by the action selection system 120 using two or more base polices in the set of base policies 130 and a switching probability for switching among the two or more base policies. As one example the set of composite policies 140 may comprise a set of depth-m compositions of the base policies, e.g. it may comprise the set of all the composite policies that switch between (exactly) m, not necessarily distinct, base policies.

Generating composite policies from the base policy set 130 allows the action selection system 120 to extend its pool of action selection policies to include a much wider class of policies having different properties than one another, e.g., to also include non-Markov policies in addition to Markov policies, from which an optimal or near-optimal policy (in terms of the rewards received from the environment 106 as a result of the agent 104 performing the actions 102 selected using the policy) may be discovered. In reinforcement learning, the Markov property assumes that a future state of the environment is dependent only on the current state of the environment (and not any history states). Thus a Markov policy selects actions dependent only on the current state of the environment, and a non-Markov policy can depend on a history of states of the environment.

Each composite policy is an action selection policy that switches between using a subset of the base policies 134A-M with a given switching probability. When used, each composite policy defines, at each of multiple time steps, which one (and at most one) of the base policies 134A-M will be used to control the agent in accordance with the given switching probability, and subsequently selects an action to be performed by the agent in accordance with the determined base policy.

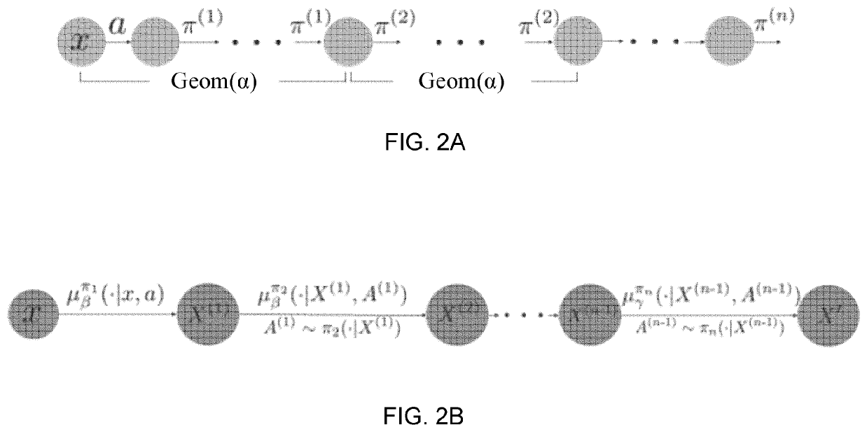

FIG. 2A is an illustration of a rollout for selecting an action using a composite policy that can be generated according to some implementations of the action selection system 120. The example composite policy shown in FIG. 2A may be viewed as a geometric switching policy because a Geometric probability distribution function is used to determine how to switch from a currently used base policy to another base policy in the base policy set over a sequence of time steps. A geometric probability distribution calculates the probability that a switch occurs after T time steps, where at each time step the switch might occur with a switching probability α. A geometric probability distribution function can be denoted by the value of, e.g. Geometric(α) sampling from which defines the probably of no switch after T steps, where the switching probability α can be any real value between zero and one defined by a user of the system 120.

The example rollout in FIG. 2A thus begins with selecting action(s) a in response to observation(s) x using a first base policy π⁽¹⁾ in the set for T₁˜Geometric(α) time steps, at which point a switch is made to the second base policy π⁽²⁾. Once a switch from the first base policy π⁽¹⁾ to the second base policy π⁽²⁾ is made, the second base policy π⁽²⁾ is used to select further action(s) a in response to further observation(s) x for Tᵢ₊₁˜Geometric(α) time steps, at which point a switch from the second base policy π⁽²⁾ to the third base policy π⁽³⁾ happens. This process repeats until reaching the last base policy π⁽ⁿ⁾. In this way, the base policies in the base policy set are sequentially used one after another to select one or more supposed actions in response to one or more consecutive (predicted) observations as if to control the agent to perform the same task when interacting with the environment.

Other implementations of the action selection system 120 can compute such a switching probability for switching among different base policies in the base policy set 130 included in each composite policy by using other suitable probability distribution functions. For example, a negative binomial distribution function, a Poisson distribution function, or the like may be used to compute the switching probability defining how the composite policy could switch from one base policy to another base policy. In addition, each composite policy need not begin with the first base policy 134A in the base policy set 130, and each composite policy need not iterate through all base policies 134A-M in the base policy set 130. In fact, a composite policy may select actions in accordance with a same base policy at two or more nonadjacent time steps (e.g., by switching back and forth between two base policies in accordance with a given switching probability).

The action selection system 120 includes one environment dynamics neural network corresponding to each base policy in the base policy set 130. Each environment dynamics neural network 150 is configured to receive an environment dynamics network input that includes (i) an input observation 108 characterizing an input state of the environment 106 and (ii) a respective action selected by using the corresponding base policy to be performed by the agent in response to the input observation, and to process the environment dynamics network input in accordance with parameters of the environment dynamics neural network to generate a predicted future observation characterizing a future state of the environment 106.

Likewise, each environment dynamics neural network 150 can generate a predicted future observation characterizing a respective further future state of the environment by processing an environment dynamics network input that includes (i) an input observation characterizing a future state of the environment (i.e., a state that is one or more time steps after the current state) and (ii) a respective action selected by using the corresponding base policy to be performed by the agent in response to the input observation.

The predicted future observation may be generated deterministically, e.g., by an output of the environment dynamics neural network, or stochastically, e.g., where the output of the environment dynamics neural network parameterizes a distribution from which the predicted future observation is sampled.

Each environment dynamics neural network 150 can have any appropriate architecture that allows the network 150 to map an input observation and an action to a future observation prediction. In some implementations, the environment dynamics neural networks 150 comprise feedforward neural networks, e.g., multi-layer perceptrons (MLPs) or autoencoder models, with the same or similar architectures but different parameter values. In a particular example, the environment dynamics neural network 150 can be a conditional β-Variational Autoencoder (conditional β-VAE) model that includes an encoder neural network configured to process an input observation and an action to generate an encoder output from which a latent representation that includes one or more latent variables can be generated, and a decoder neural network configured to process latent representation to output the future observation prediction. β-VAEs are described in Higgins et al. “Beta-VAE: Learning basic visual concepts with a constrained variational framework”, Proc. Intl Conference on Learning Representations, 2016.

The action selection system 120 includes one or more reward estimators 160 associated with the environment 106. Each reward estimator 160 is configured to receive a reward estimator input that includes a current observation 108 characterizing the current state of the environment 106 and, optionally, a previous action performed by the agent in response to a previous observation characterizing an immediately previous state of the environment 106, and to process the reward estimator input to generate an estimated value of a current reward 110 that will be received by the agent at the current state of the environment 106.

Likewise, each reward estimator 160 can generate an estimated value of a future reward that will be received by the agent at a future state of the environment 106 by processing a predicted future observation characterizing the future state of the environment 106 that has been generated by the environment dynamics neural network 150.

In general, the reward 110 is a numerical value. The reward 110 can be estimated by a reward estimator 160 based on any event or aspect of the environment 106, and optionally also on a previous action performed by the agent in response to a previous observation characterizing a previous state of the environment 106. For example, the current reward may indicate whether the agent 104 has accomplished a task or the progress of the agent 104 towards accomplishing the task.

In some implementations, the reward estimator 160 is a deterministic reward estimator, e.g., that computes the estimated value of the current reward using a known reward function. For example, the reward function may be known in many robotics tasks or other object manipulation tasks, where a specified value of the reward will be received in a state of the environment in which a robot has a specified configuration or navigates to a specified destination in the environment.

In some implementations, the reward estimator 160 is a machine learning model, e.g., a reward estimator neural network, that computes the estimated value of the current reward from the reward estimator input in accordance with parameters of the reward estimator neural network. The trained parameter values may have been determined through supervised training of the reward estimator neural network, e.g., based on minimizing a mean squared error between predicted reward and observed reward from the environment, on training data generated as a result of the agent interacting with the environment.

In some implementations, the system can include multiple reward estimators 160 that correspond to different environments and/or tasks from which a particular reward estimator corresponding to the environment 106 can be selected. For example, one can be a deterministic reward estimator, and another can be a machine learning model-based reward estimator.

To evaluate each composite policy in the set of composite policies 140, the action selection system 120 makes use of a reward estimation technique based on outputs generated by using the multiple environment dynamics neural networks 150 and the one or more reward estimators 160. The evaluation results include a respective estimated value for each composite policy in a composite policy set. The estimated value is typically dependent on an estimate of the total rewards that would result from the agent 104 performing the action 102 selected using a composite policy in response to the current observation 108 and thereafter selecting future actions performed by the agent using the composite policy.

In some implementations, this reward estimation technique can be independent of the reward 110 (or more specifically, independent of how the reward values may be calculated for each task) and therefore the same technique may be reused for different tasks (having different rewards) within the same environment 106. In some implementations, this estimated value is a “current” value of a composite policy determined with respect to the current state of the environment. That is, the estimated value may be an estimate of a value of the composite policy when used to select a current action 102 to be performed by the agent 104 in response to receiving an observation 108 characterizing the current state of the environment 106, and the estimates of the value of the same composite policy may be different when the composite policy is select actions in response to receiving different observations characterizing different states of the environment.

Applying the reward estimation technique to determine the estimated value for each composite policy includes using the environment dynamics neural networks 150 to predict future observations characterizing future states that the environment 106 would transition into as a result of agent 104 performing actions selected using a respective base policy, and then using the predicted future observations to determine a respective estimated value for each composite policy in a composite policy set.

In particular, some implementations of the reinforcement learning system 100 can use the environment dynamics neural networks 150 that correspond to the base policies to evaluate a potentially large number of composite policies with no additional training of the environment dynamics neural networks 150, and thus impose no extra computation overhead devoted to the training of the system.

Depending on the configurations of the environment dynamics neural networks 150, the action selection system 120 can determine the estimated value for each composite policy in at least two different ways. The first way is to use single-step rollout, where the multiple environment dynamics neural networks 150 are repeatedly used to make a prediction about one or more future observations of consecutive future states of the environment after the current state. The rollout represents an imagined trajectory of the environment at times after the current state, assuming that the agent performs certain actions selected in accordance with a base policy corresponding to each environment dynamics neural network 150. To generate an imagined trajectory, a current (actual) observation and a selected action are input into the network 150, to generate a predicted future observation. The predicted future observation is then input into the network 150 again together with another selected action, to generate another predicted future observation. This process is carried out in total of n times, where n≥1, to produce a rollout trajectory of n rollout states.

In this first way, the estimated value for a composite policy can for example be computed as a weighted or unweighted sum of the estimated values of the rewards determined by the reward estimator 160 from observations of the states of the environment included in the trajectory.

The second way is to use multi-step rollout to make predictions over longer (e.g., infinite) horizons. Instead of modeling the state transitions of the environment by repeatedly carrying out the single-step rollout process, in multi-step rollout, an environment dynamics neural network 150 predicts a future state-visitation distribution of the agent over all possible future states at the nth time step forward from the current state (observation) of the environment, assuming that the agent performs certain actions selected in accordance with a base policy corresponding to the environment dynamics neural network 150. This future state-visitation distribution at the nth time step may be a weighted distribution over the possible future states of the environment, weighted according to a given discount factor.

An environment dynamics neural network of the type described above, for use in multi-step rollout, may also be termed a γ-model, because of the dependence of its probabilistic horizon on a discount factor γ used by the base policy. Such models are described in more detail in Janner, M., Mordatch, I., and Levine, S. Gamma-models: Generative temporal difference learning for infinite horizon prediction. In Advances in Neural Information Processing Systems, 2020.

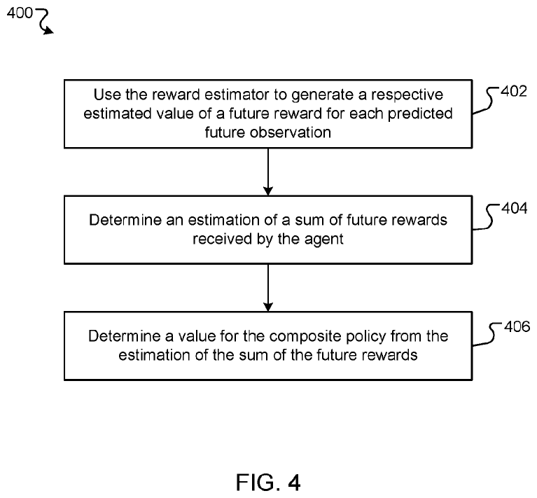

In this second way, the estimated value for a composite policy can for example be computed by applying a sampling-based reward estimation technique which estimates the rewards based on observations of future states sampled from the future state-visitation distribution, as will be described further below with respect to FIG. 4.

With either way, the action selection system 120 can then use the estimated values for the composite policies in the composite policy set 140 to select a current action 102 to be performed by the agent 104 in response to the current observation 108 characterizing the current state of the environment 106. For example, the system can select the action 102 to be performed by the agent 104 according to the composite policy that has the highest estimated value from amongst all the composite policies in the composite policy set 140. As one example in some implementations, as described further below, the values for the composite policies each comprise a state-action value, i.e. Q-value, and these Q-values can be used to select the action 102.

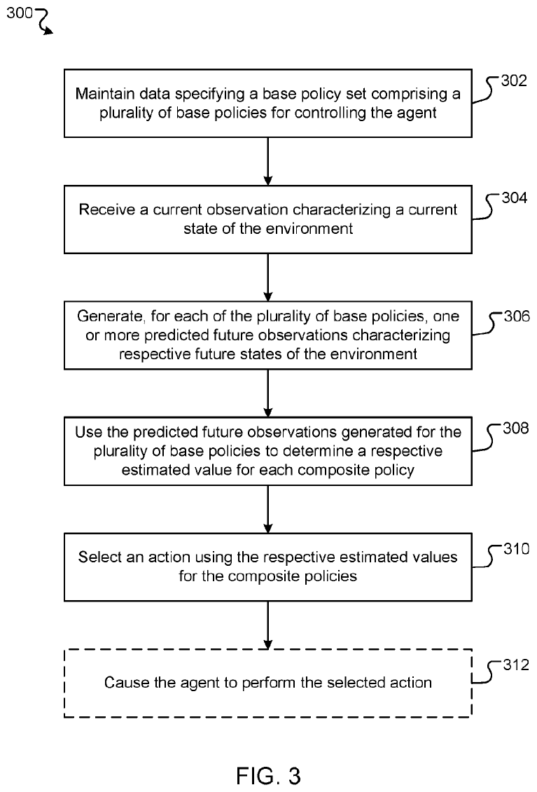

FIG. 3 is a flow diagram of an example process 300 for controlling a reinforcement learning agent in an environment. For convenience, the process 300 will be described as being performed by a system of one or more computers located in one or more locations. For example, a reinforcement learning system, e.g., the reinforcement learning system 100 of FIG. 1, appropriately programmed, can perform the process 300.

The system maintains data specifying a base policy set that includes multiple base policies for controlling the agent (step 302). For example, the maintained data can include source code that defines the logic that corresponds to a fixed base policy for selecting actions, architecture data that specifies the network architecture, parameter data that specifies the trained parameters values, or both of an instance of a base policy neural network that corresponds to a learned base policy for selecting actions, and so on.

The system also maintains data specifying a composite policy set that includes multiple composite policies for controlling the agent. Each composite can be generated from two or more base policies in the base policy set. In each composite policy, each of two or more of the multiple base policies are subsequently used to select one or more actions to be performed by the agent in response to a corresponding number of consecutive observations characterizing different states of the environment.

In some cases, the corresponding number of consecutive future observations in response to which each base policy is used to select actions can be determined in accordance with a given switching probability α, where the value of α may be defined by a user of the system. In these cases, in each composite policy, the corresponding number of consecutive observations in response to which each base policy is used to select actions can be determined by evaluating a probability distribution function, e.g., a geometric distribution function Geometric(α), over the given switching probability α.

The system receives a current observation characterizing a current state of the environment at the current time step (step 304). As described above, in some cases the current observation can also include information derived from the previous time step, e.g., the previous action performed, the reward received at the previous time step, or both.

The system generates, for each of one or more of the multiple base policies, one or more predicted future observations characterizing respective future states of the environment that are subsequent to the current state of the environment by using an environment dynamics neural network that corresponds to the base policy (step 306). For example, the system can generate one or more predicted future observations for every base policy in a subset of the multiple base policies that are used in a composite policy.

Each environment dynamics neural network is configured to receive an environment dynamics network input that includes (i) an input observation characterizing an input state of the environment and (ii) a respective action selected by using the corresponding base policy to be performed by the agent in response to the input observation, and to process the environment dynamics network input to output a predicted future observation characterizing a respective future state of the environment.

The predicted future observation may be generated deterministically, e.g., by an output of the environment dynamics neural network, or stochastically, e.g., where the output of the environment dynamics neural network parameterizes a distribution from which the predicted future observation is sampled.

FIG. 2B is an illustration of generating predicted future observations. As shown in FIG. 2B, a first predicted future observation X⁽¹⁾ characterizing a first future state of the environment can be generated through sampling from a future state-visitation distribution μ_{β}^{π}^{₁} generated by an environment dynamics neural network that corresponds to the first base policy π₁. To generate an output that parameterizes the distribution μ_{β}^{π}^{₂}, the environment dynamics neural network processes (i) the current (actual) observation x and (ii) a selected action a. Here β is a discount factor that defines a time horizon that is the same as or shorter than γ; i.e. 0≤β≤γ.

Likewise, a second predicted future observation X⁽²⁾ characterizing a second future state of the environment can be generated through sampling from a future state-visitation distribution μ_{β}^{π}^{₂} generated by an environment dynamics neural network that corresponds to the second base policy π₂. To generate an output that parameterizes the distribution μ_{β}^{π}^{₂}, the environment dynamics neural network processes (i) the first predicted future observation X⁽¹⁾ generated by the network at a previous time step and (ii) an action A⁽¹⁾ selected by using the second base policy π₂ to be performed by the agent in response to the first predicted future observation. The system can repeat this process for multiple times, e.g., until reaching a terminal state X′ of the environment.

The system uses the predicted future observations generated for the multiple base policies to determine a respective estimated value for each composite policy in a composite policy set with respect to the current state of the environment (step 308). As will be explained in more detail with reference to FIG. 4, this includes generating, for each predicted future observation, a respective estimated value of a future reward (that will be received by an agent when the environment is in a future state characterized by the predicted future observation), and then using both the predicted future observations and the respective estimated values of the future rewards to determine the respective estimated value for each composite policy.

The estimated values of the future rewards can be determined by using a reward estimator associated with the environment, where the reward estimator is configured to receive a reward estimator input that includes the current observation characterizing the current state of the environment and, optionally, a previous action performed by the agent in response to a previous observation characterizing an immediately previous state of the environment, and to process the reward estimator input to generate an estimated value of a current reward received by the agent at the current state of the environment.

The reward estimator can either be configured as a deterministic reward estimator, e.g., that computes the estimated value of the current reward using a known reward function, or alternatively can be configured as a trained machine learning model, e.g., a reward estimator neural network that computes the estimated value of the current reward in accordance with parameters of the reward estimator neural network.

The system selects, as a current action to be performed by the agent in response to the current observation characterizing the current state of the environment, an action using the respective estimated values for the composite policies (step 310). For example, the system can select the action to be performed by the agent according to the composite policy that has the highest estimated value from amongst all the composite policies in the composite policy set. As mentioned above, this includes selecting an action at the time step in accordance with a particular base policy from amongst all the multiple base policies defined by the selected composite policy.

In some cases, the system can then cause the agent to perform the selected action in response to the current observation (312), for example by instructing the agent to perform the action or passing a control signal to a control system for the agent.

FIG. 4 is a flow diagram of an example process 400 for determining an estimated value for a composite policy with respect to a current state of an environment. For convenience, the process 400 will be described as being performed by a system of one or more computers located in one or more locations. For example, a reinforcement learning system, e.g., the reinforcement learning system 100 of FIG. 1, appropriately programmed, can perform the process 400.

In general, the system can repeatedly perform the process 400 for each of the multiple composite policies to determine an estimated value for the composite policy.

The system uses the reward estimator to generate a respective estimated value of a future reward for each predicted future observation that has been generated for the composite policy (step 402).

The system determines, in accordance with a given discount factor, and from the respective estimated values of the future rewards, an estimation of a sum of future rewards (step 404). The value of the given discount factor, which is typically between zero and one, may be defined or otherwise specified by a user of the system. In particular, this estimation approximates the total future rewards that will be received by the agent if the agent were to perform actions selected by using the composite policy, in response to receiving one or more future observations characterizing future states of the environment beginning from the current state of the environment characterized by the current observation.

The system determines a value for the composite policy from the estimation of the sum of the future rewards (step 406). For example, the value for the composite policy can be computed as a sum of (i) a current reward received by the agent at the current state of the environment and (ii) the estimation of the sum of future rewards.

For example, the value for the composite policy may comprise a Q-value Q(x, a) for a current observation, and a current action to be performed. Such a value can be computed using the following equation:

$$r ( x ) + \frac{γ}{1 - γ} \times [ {\sum }_{m = 1}^{n - 1} \frac{1 - γ}{1 - β} {( \frac{γ - β}{1 - β} )}^{m - 1} r ( {X}^{( m )} ) + {( \frac{γ - β}{1 - β} )}^{n - 1} r ( {X}^{′} ) ] ,$$

where (X⁽⁰⁾, A⁽⁰⁾)=x,a), X^{(m)}˜μ_{β}^{π}^{ₘ} (⋅|, (X^{(m-1)}, A^{(m-1)}), A^{(m)}˜πₘ₊₁(⋅|X^{(m)}), X′˜μ_{β}^{π}^{ₙ} (⋅|X⁽ⁿ⁻¹⁾, A⁽ⁿ⁻¹⁾; r denotes the reward estimator; n is the number rollout states that begin from the state at the current time step, which is typically greater than one; α is the switching probability; and β=γ(1−α), wherein γ is the discount factor. This approach uses two sets of environment dynamics neural networks, μ_{β}^{π}^{ₘ} and μ_{γ}^{π}^{ₘ}.

In general, the process 300 or 400 can be performed as part of selecting an action in response to the current observation for which the optimal action, i.e., the action that once performed would result in a maximized reward to be received from the environment as a result of the agent performing the selected action, is not known.

The process 300 or 400 can also be performed as part of processing training inputs generated as a result of the interaction of the agent 104 (or another agent) with the environment 106 (or another instance of the environment), in order to train the environment dynamics neural networks to determine trained values for the parameters of the environment dynamics neural networks, and, in some cases, to determine the trained values for the parameters of the reward estimator neural networks, the trained values for the parameters of the base policy neural networks, or both. The training inputs can be stored in a replay buffer and retrieved therefrom, e.g., through uniform sampling. Each training input can be or include a state-action pair (xₜ, aₜ), where the observation at a given time step/is denoted xₜ, and based on it the action selection system 120 selects an action aₜ which the agent 104 performs at that time step.

During training, the system can incorporate any number of techniques to improve the speed, the effectiveness, or both of the training process. For example, the training of the environment dynamics neural networks that are configured as conditional β-VAE models can involve applying a stochastic gradient descent with reparameterization technique to optimize a negative cross-entropy temporal-difference (CETD) loss function computed by:

$${{X}^{′} \sim ( {T}_{β}^{π} {\overline{μ}}_{θ} ) ( \cdot \vert x , a )}_{} [ {z \sim {q}_{ψ} ( \cdot \vert x , a , {X}^{′} )}_{} [ log ( \frac{{μ}_{θ} ( {X}^{′} \vert x , a , z )}{{q}_{ψ} ( z \vert x , a , {X}^{′} )} ) ] ]$$

where θ denotes the parameters of the environment dynamics neural network, z are the latent variable(s) in a VAE model, and ψ denotes the (trainable parameters) of posterior approximation function.

As another example, a hyperparameter search technique can be used to search for optimized values for one or more of: the learning rate, the β_{VAE} parameter for the environment dynamics neural networks, or the VAE latent dimension.

As another example, to train the base policy neural networks, the system can use one of the off-policy RL training techniques described in more detail at Abdolmaleki, A., Springenberg, J. T., Tassa, Y., Munos, R., Heess, N., and Riedmiller, M. Maximum a posteriori policy optimisation. In Proceedings of the International Conference on Learning Representations, 2018.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for controlling a reinforcement learning agent in an environment, the method comprising:
maintaining data specifying a base policy set comprising a plurality of base policies for controlling the agent;
receiving a current observation characterizing a current state of the environment;
generating, for each of one or more of the plurality of base policies, one or more predicted future observations characterizing respective future states of the environment that are subsequent to the current state of the environment by using an environment dynamics neural network that corresponds to the base policy, wherein each environment dynamics neural network is configured to receive an environment dynamics network input comprising an input observation characterizing an input state of the environment and a respective action selected by using the corresponding base policy to be performed by the agent in response to the input observation, and to process the environment dynamics network input to generate a predicted future observation characterizing a respective future state of the environment;
using the predicted future observations generated for the plurality of base policies to determine a respective estimated value for each composite policy in a composite policy set with respect to the current state of the environment, wherein each composite policy is generated based on the base policy set and, in each composite policy, each of one or more of the plurality of base policies are subsequently used to select actions to be performed by the agent in response to a corresponding number of consecutive future observations; and
selecting, as a current action to be performed by the agent in response to the current observation characterizing the current state of the environment, an action using the respective estimated values for the composite policies.

2. The method of claim 1, wherein selecting action using the respective estimated values for the composite policies comprises:
selecting an action according to the composite policy that has a highest estimated value.

3. The method of claim 1, wherein in each composite policy, the corresponding number of consecutive future observations in response to which each base policy is used to select actions is determined in accordance with a given switching probability.

4. The method of claim 3, wherein the given switching probability is a value received from a user that is between zero and one.

5. The method of claim 3, wherein in each composite policy, the corresponding number of consecutive future observations in response to which each base policy is used to select actions is determined by evaluating a geometric probability distribution function over the given switching probability.

6. The method of claim 1, further comprising maintaining a reward estimator associated with the environment, wherein the reward estimator is configured to receive a reward estimator input comprising the current observation characterizing the current state of the environment, and to process the reward estimator input to generate an estimated value of a current reward received by the agent at the current state of the environment.

7. The method of claim 6, wherein the current reward is dependent on a previous action performed by the agent in response to a previous observation characterizing a previous state of the environment.

8. The method of claim 6, wherein the reward estimator is configured as a deterministic reward estimator.

9. The method of claim 6, wherein the reward estimator is configured as a machine learning model trained on training data generated as a result of the agent interacting with the environment.

10. The method of claim 6, wherein using the predicted future observations to determine the respective estimated value for each composite policy with respect to the current state of the environment comprises:
using the reward estimator to generate a respective estimated value of a future reward for each predicted future observation; and
determining, in accordance with a given discount factor, and from the respective estimated values of the future rewards, an estimation of a sum of future rewards received by the agent if the agent were to perform actions selected by using the composite policy beginning from the current state of the environment; and
determining a value for the composite policy from the estimation of the sum of the future rewards.

11. The method of claim 10, wherein determining the estimation of the sum of future rewards comprises receiving, as the given discount factor, a user-defined value that is between zero and one.

12. The method of claim 1, wherein each environment dynamics neural network is trained based on optimizing a cross-entropy temporal-difference (CETD) loss.

13. The method of claim 1, wherein each environment dynamics neural network is configured as a respective conditional β-VAE model.

14. The method of claim 1, wherein maintaining data specifying the base policy set comprising the plurality of base policies for controlling the agent comprises:
maintaining a respective base policy neural network that corresponds to each of one or more of the plurality of base policies, wherein each base policy neural network is configured to receive a base policy network input comprising the current observation characterizing the current state of the environment, and to process the base policy network input to generate a base policy network output that specifies an action to be performed by the agent in response to the current observation.

15. The method of claim 1, wherein the agent is a mechanical agent or other hardware, the environment is a real-world environment, and the observation comprises data from one or more sensors configured to sense the real-world environment.

16. The method of claim 15, wherein the mechanical agent comprises a robot or a vehicle.

17. The method of claim 15, wherein the other hardware comprises a heater, a cooler, a humidifier, or other hardware that modifies a property of air in the real-world environment.

18. The method of claim 1, wherein the agent is a computer-implemented task manager, the environment is a physical state of a computational device, and the observation comprises data from one or more sensors configured to sense the state of the computational device.

19. The method of claim 1, wherein the agent is a software program implemented on one or more computers, the environment is a real-world environment, and the observation comprises data from one or more sensors configured to sense the real-world environment.

20. The method of claim 1, further comprising causing the agent to perform the action selected by using the respective estimated values for the composite policies.

21. One or more computer-readable storage media storing instructions that when executed by one or more computers cause the one or more computers to perform the respective operations of any one of the methods of comprising:
maintaining data specifying a base policy set comprising a plurality of base policies for controlling the agent;
receiving a current observation characterizing a current state of the environment;
generating, for each of one or more of the plurality of base policies, one or more predicted future observations characterizing respective future states of the environment that are subsequent to the current state of the environment by using an environment dynamics neural network that corresponds to the base policy, wherein each environment dynamics neural network is configured to receive an environment dynamics network input comprising an input observation characterizing an input state of the environment and a respective action selected by using the corresponding base policy to be performed by the agent in response to the input observation, and to process the environment dynamics network input to generate a predicted future observation characterizing a respective future state of the environment;
using the predicted future observations generated for the plurality of base policies to determine a respective estimated value for each composite policy in a composite policy set with respect to the current state of the environment, wherein each composite policy is generated based on the base policy set and, in each composite policy, each of one or more of the plurality of base policies are subsequently used to select actions to be performed by the agent in response to a corresponding number of consecutive future observations; and
selecting, as a current action to be performed by the agent in response to the current observation characterizing the current state of the environment, an action using the respective estimated values for the composite policies.

22. A system comprising one or more computers and one or more storage devices storing instructions that when executed by one or more computers cause the one or more computers to perform operations comprising:
maintaining data specifying a base policy set comprising a plurality of base policies for controlling the agent;
receiving a current observation characterizing a current state of the environment;
generating, for each of one or more of the plurality of base policies, one or more predicted future observations characterizing respective future states of the environment that are subsequent to the current state of the environment by using an environment dynamics neural network that corresponds to the base policy, wherein each environment dynamics neural network is configured to receive an environment dynamics network input comprising an input observation characterizing an input state of the environment and a respective action selected by using the corresponding base policy to be performed by the agent in response to the input observation, and to process the environment dynamics network input to generate a predicted future observation characterizing a respective future state of the environment;
using the predicted future observations generated for the plurality of base policies to determine a respective estimated value for each composite policy in a composite policy set with respect to the current state of the environment, wherein each composite policy is generated based on the base policy set and, in each composite policy, each of one or more of the plurality of base policies are subsequently used to select actions to be performed by the agent in response to a corresponding number of consecutive future observations; and
selecting, as a current action to be performed by the agent in response to the current observation characterizing the current state of the environment, an action using the respective estimated values for the composite policies.
